(19) United States
(12) Patent Application Publication
(10) Pub. No.: US 2015/0169599 A1
(43) Pub. Date: Jun. 18, 2015

(54) System and method for electronic mail attachment processing, offloading, retrieval, and grouping

(71) Applicant: III Holdings 1, LLC, Wilmington, DE (US)

(72) Inventors: R. Alan Burnett, Bellevue, WA (US); David A. Feinleib, Palo Alto, CA (US)

(21) Appl. No.: 14/539,207

(22) Filed: Nov. 12, 2014

Related U.S. Application Data
(60) Provisional application No. 61/903,349, filed on Nov. 12, 2013.

(51) Int. Cl. G06F 17/30; H04L 12/58

(52) U.S. Cl. CPC G06F 17/30088; H04L 51/08; G06F 17/3033; G06F 17/30109; G06F 17/30203

(57) ABSTRACT

Method, system, and software for the processing, offloading, retrieval, and efficient grouping of electronic mail message file attachments. Software processes and methods are disclosed that are used in server software, client software, and algorithms to process electronic mail attachments, store them to a local computer or remote server and to retrieve such attachments. Additionally, processes for automatically and logically grouping related attachments together according to a variety of heuristics are disclosed, as well as processes for automatically deleting or archiving attachments in response to detection that electronic mail messages are deleted.

### FIELD OF THE INVENTION

The field of invention relates generally to electronic mail (email), and more particularly concerns techniques for the offloading, retrieval, and efficient grouping of electronic mail file attachments.

### BACKGROUND INFORMATION

It can be appreciated that sending electronic mail messages with files attached to them has become commonplace in recent years, especially with more widely available high speed internet access. This progress has created a problem for electronic mail systems, however, in that electronic mail messaging systems must store large numbers of file attachments, which are typically large in size. Storing a large number of large files can result in messaging system performance degradation, lack of storage for newly received attachments, and the unnecessary re-transmission and duplicate storage of file attachments.

A related problem exists in that electronic mail message recipients must deal with hundreds or thousands of message attachments. To find a message attachment, a user must open up his or her email program and search through email messages and their attachments, and then save the desired attachment to disk in a multi-step and time-consuming process.

Moreover, electronic mail message attachments accessed via an electronic mail program are only viewable by the user through a message-based interface that orders the messages based on message subject, date received, sender, or other attributes of the message itself, rather than by the attributes of the message attachment or attachments, such as the contents, filename, author, or creation date of the attachment. The lack of an attachment-based grouping interface becomes especially problematic for electronic mail message recipients who receive numerous related files, such as successive revisions to an electronic document; the lack of attachment-based grouping can result in a message recipient reading or editing a version of a document or other file received as a message attachment other than the most recent one.

Clearly then, conventional electronic mail messaging system in which duplicate file attachments are stored, and message attachments are only accessible via a limited user interface in which attachments are only viewable associated with their messages rather than based on their own attributes provides a less than optimal operating environment with unnecessary consumption of machine resources as well as a poor user experience. Accordingly, it would be advantageous to provide enhances techniques for storing and managing access to electronic mail attachments to make them easier to access, group, and search.

### SUMMARY OF THE INVENTION

The invention relates generally to a system and method for the storage, retrieval, and visual grouping of electronic mail file attachments. The invention also relates to software processes and methods that are used in server software, client software, and algorithms to process electronic mail attachments, store them to a local or remote server and to retrieve such attachments. Additionally, the invention relates to processes for automatically and logically grouping related attachments together according to a variety of heuristics, and a user interface for displaying attachments and grouped attachments to the user.

In one aspect of the invention, a software module running on a server computer running a server operating system and electronic mail messaging and collaboration software operates as a plug-in to the messaging and collaboration software, interfacing with the messaging software application programming interface (API) to process electronic mail messages, to separate file attachments from messages, and to modify electronic mail messages to include a Universal Naming Convention (UNC) text string, a Universal Resource Locator (URL) text string, or a shortcut file that points to file attachments that have been stored to disk. The software module includes the capability to store one or more attachments to a server-local disk, to a remote server located on a private Local Area Network or Wide Area Network, a logical server hosted by a data center or the like, or to a server located on the Internet.

In another aspect of the invention, a client-based module, that is, software running on a computer client running a client operating system, runs as a plug-in in a client electronic messaging application, and connects to a server messaging and collaboration application through an API to process electronic mail messages and associated file attachments stored in the mailbox of a particular user. In an alternative embodiment, the software plug-in does not connect to the server, but rather processes electronic mail messages that are stored locally on the client computer.

In yet another aspect of the invention, the plug-in running on the server processes messages in-line, that is, as they are received by the server, by hooking the message receiving API of the server messaging software. In this embodiment, the plug-in supports separating the attachment from the message and storing it to disk, and inserting a text link pointing to the file attachment into the message; inserting a stub executable program into the message; or updating an index in a server database that associates file attachments, electronic mail messages, and on-disk or remote-server locations.

In yet another aspect of the invention, a software plug-in running m a messaging server application hooks the attachment retrieval interface of the messaging server application, such that any time an attachment is requested, the software plug-in is notified of the request and can return the attachment to the messaging server rather than the messaging server software retrieving the attachment itself. In this way, a file attachment appears to a user to be attached to an electronic mail message when in fact just a small stub file is attached.

In another aspect of the invention, a software module running on a client computer hooks the message display and attachment retrieval interfaces of a client electronic messaging application, such that any time an attachment is requested, the software module is notified of the request and returns the attachment as requested, regardless of where the attachment file is stored.

In another aspect of the invention, a software module running on a server or a client computer automates the currently manually process of grouping related attachments together.

In another aspect of the invention, an electronic mail messaging server is implemented (as contrasted with the aforementioned plug-in implementation), in which the messaging server directly handles the off-loading of file attachments to local or remote storage. In one aspect of off-loading, access activity for file attachments stored locally is monitored, and if a request to access a file exceeds a predetermined time period the file is archived by automatically moving it to a remote storage location and updating a location of the file.

In yet another aspect of the invention, a method is implemented for deleting a file attachment stored on a network computer if all occurrences of messages pointing to the file are deleted, freeing up critical disk space.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic drawing illustrating the system architecture of one embodiment of an email processing system, showing the relationship between various client and server software and hardware components.

FIG. 2 is a schematic drawing illustrating the relationship between various computers running electronic messaging software and enabling the deletion of a message with attachment on a plurality of computers to cause the deletion of an attachment from a location at which it was previously stored.

FIG. 3a is a representation of an email application user interface (UI) Illustrating a file attachment to an electronic mail message.

FIG. 3b is a representation of an email application UI illustrating a file attachment replaced as a link on a local hard drive location.

FIG. 3c is a representation of an email application UI illustrating a file attachment replaced with a Universal Naming Convention (UNC) pointer to a file on a local file server.

FIG. 3d is a representation of an email application UI illustrating a file attachment replaced with a Universal Resource Locator (URL) pointer to the file attachment stored on a local area network server operating in file and web server roles.

FIG. 3e is a representation of an email application UI illustrating a file attachment replaced with a Universal Resource Locator (URL) pointer to the file attachment stored on an Internet accessible web server.

FIG. 3f is a representation of an email application UI illustrating a file attachment stored on a local or remote computer retrieved by a software plug-in or electronic mail program.

FIG. 3g is drawing illustrating Universal Naming Convention (UNC) and Universal Resource Locator (URL) text string file location descriptors.

FIG. 4 is a flowchart illustrating operations and logic performed by a server-based system for processing electronic mail messages and off-loading the attachments to disk or a remote server, while replacing the attachment with a Universal Naming Convention (UNC) locator or Universal Resource Locator (URL) in the message body.

FIG. 5 is a flowchart illustrating operations and logic performed by a client-based system for processing the messages for a specific electronic mailbox and offloading attachments. FIG. 5a is a flowchart illustrating operations and logic of 5A of FIG. 5 performed by a client-based system for processing the messages for a specific electronic mailbox and offloading attachments. FIG. 5b is a flowchart illustrating operations and logic of 5B of FIG. 5 performed by a client-based system for processing the messages for a specific electronic mailbox and offloading attachments.

FIG. 6 is a flowchart illustrating operations and logic performed during processing of an electronic mail message attachment and its attachment inline, that is, upon receipt of the message.

FIG. 7 is a flowchart illustrating operations and logic performed in connection with hooking the attachment retrieval interface of an electronic messaging system and returning a requested attachment from a local disk or a remote server upon request.

FIG. 8 is a flowchart illustrating operations and logic performed by an alternative embodiment for hooking the attachment retrieval interface and returning a requested attachment.

FIG. 9 is a drawing of programmatically grouping attachments to electronic mail messages.

FIG. 10 is a drawing showing various filename text strings and the results of a string comparison algorithm.

FIG. 11 is a flowchart illustrating operations and logic performed by one embodiment of a process for detecting the transmission of a message with attachment and the storing of an associated message ID and recipient count to a database.

FIG. 12 is a flowchart illustrating operations and logic performed by one embodiment of a process for detecting the deletion of a message with an attachment and the corresponding notification to a message sender indicating the message deletion.

FIG. 13 is flowchart illustrating operations and logic performed in connection with the receiving of an attachment deletion notification message, the processing and verification of said message, and the deletion of a file if indicated.

FIG. 14 is a flowchart illustrating operations and logic performed by one embodiment of a process for determining if a message pointing to a file attachment has not been recently accessed by a message recipient, and then sending a message notifying the sender system of non-access, causing the archiving of the attachment.

FIG. 15a is a frontal isometric view of an exemplary blade server chassis in which a plurality of server blades are installed.

FIG. 15b is a rear isometric view of the blade server chassis of FIG. 15a.

FIG. 15c is an isometric frontal view of an exemplary blade server rack in which a plurality of rack-mounted blade server chassis corresponding to FIGS. 15a and 15b are installed.

FIG. 16 shows details of the components of a typical server blade, according to one embodiment.

FIG. 17 is a schematic block diagram illustrating various components of an exemplary user equipment device, according to one embodiment.

### DETAILED DESCRIPTION

Embodiments of techniques for electronic mail attachment processing, offloading, retrieval, and grouping are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

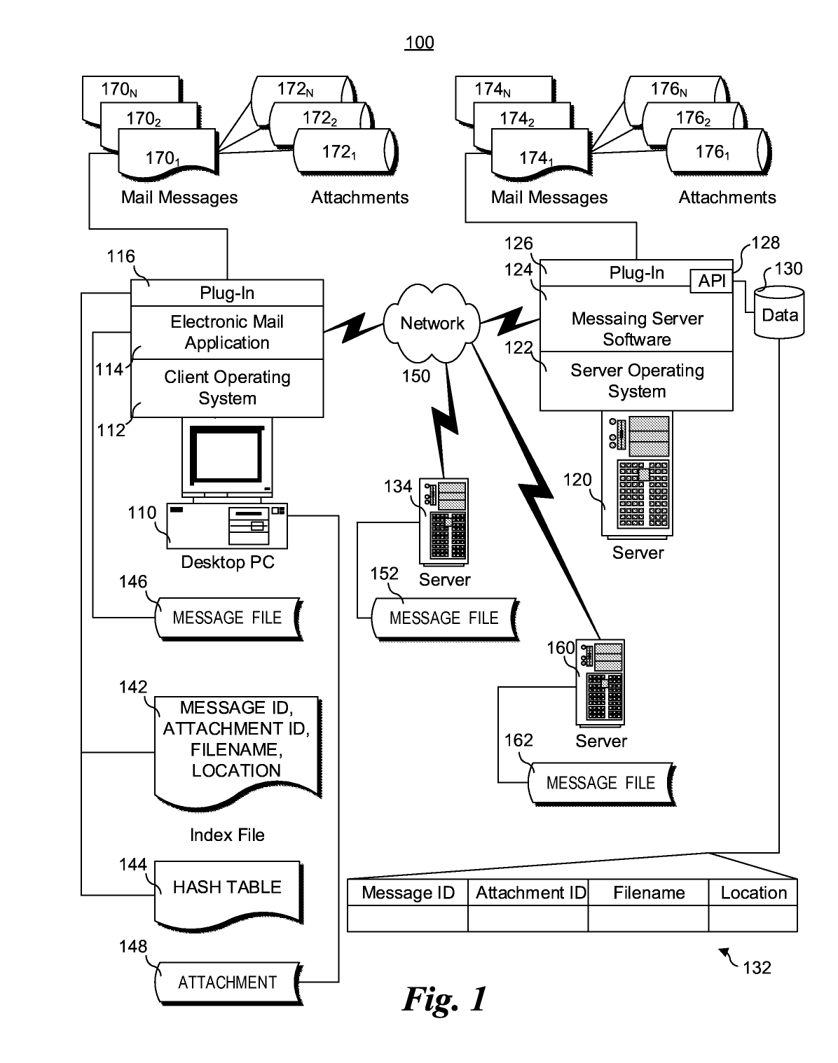

FIG. 1 is a schematic diagram illustrating one embodiment of a system architecture for message processing and attachment offloading in both client and server environments. System 100 includes desktop personal computer (PC) 110, running a client operating system 112 that hosts an electronic mail application 114. Server computer 120 runs a server operating system 122 and messaging server software 124, which sends and receives electronic mail messages over a network 150, and stores electronic mail messages for retrieval by electronic mail messaging clients such as electronic mail application 114. In general, network 150 is illustrative of various types of networks, including a local area network (LAN), wide area network (WAN), and the Internet, or a combination of these network types. Electronic mail application 114 allows a user of computer 110 to create, read, transmit and send electronic mail messages by communicating with messaging server software 124 over network 150. In one embodiment, messaging server software 124 comprises an instance of Microsoft Exchange Server (e.g., 2007, 2010 or 2013) and server operating system 122 comprises an instance of Microsoft Windows Server (e.g., 2008, 2012 or 2012 R2). In one embodiment, server computer 122 comprises an Intel-based platform. Other e-mail server systems may also be used, including but not limited to IBM Lotus Domino and Notes, Novell GroupWise, Oracle Collaboration Suite, VMware Zimbra Collaboration Suite, and PostPath. Likewise, other server operating systems may be used, such as various Linux- and Unix-based server OS's.

As explained below in further detail, various types of computing platforms may be deployed to perform various aspects of the embodiments disclosed herein, and the specific software and hardware identified by the illustrated embodiments are merely exemplary and are not to be limiting. For example, in addition to the aforementioned premise-based computer and server solutions, aspects of the embodiments disclosed herein may be implemented for cloud-based e-mail and collaboration services such as Google Apps and Zoho. Moreover, in addition to desktop clients, clients may also include smartphones, tables, and other mobile hand-held devices, such as Apple iOS devices (iPhone, iPad, iPod Touch), Google Android-based mobile phones and tablets from various vendors including Samsung, HTC, LG, Motorola, Sony, Leveno, and Huawei, devices running Microsoft Windows Phone OS, Surface tablets, and various vendor devices running Microsoft Windows 8, 8.1, or Windows RT.

In one implementation comprising a client-based implementation, a software plug-in 116 that is installed to run with electronic mail application 114 is employed to process electronic mail messages 170t-N, detect file attachments 172t-N, and process the file attachments. In another implementation comprising a server-based implementation, a software plug-in 126 that is installed to run with messaging server software 124 is employed to process electronic mail messages 174t-N, detect file attachments 176t-N, and process the file attachments. In the latter implementation, plug-in 126 communicates with messaging server software 124 via an Application Programming Interface (API) 128. In one implementation, plug-in 126 processes messages asynchronously; in another implementation, plug-in 126 processes messages as they are received by messaging server software 124 by communicating with messaging server software 124 via API 128. In another implementation, the functionality provided by plug-in 116 is implemented as part of electronic mail application 114. In another implementation, the functionality provided by plug-in 126 is implemented as part of messaging server software 124.

In the aforementioned client-based implementation, plug-in 116 processes mail messages 1701-N looking for possible file attachments 1721-N, and separating them from mail messages 1701-N and storing them to client computer 110 or remote server 134, as will be described later in more detail. In one implementation, plug-in 116 is also employed to retrieve file attachments that it has stored to client computer 110 or remote server 134 when an attachment is requested by the user of electronic mail application 114. In that implementation, plug-in 116 employs an index file 142 to store the location of file attachments and to identify attachments for retrieval. In one embodiment, index file 142 includes a Message ID, Attachment ID, Filename, and Location. In another implementation, a hash table 144 is employed by plug-in 116 to help in the identification and grouping of related file attachments.

In the aforementioned server-based implementation, plug-in 126 processes mail messages 1741-N by communicating with messaging server software 124 via API 128, looking for possible file attachments 1761-N, separating them from mail messages 1741-N and storing them to server computer 120 or remote server 134. In one implementation, plug-in 126 is also employed to retrieve file attachments that it has stored to server computer 120 or remote server 134 when an attachment is requested by the user of electronic mail application 114 connecting via network 150 to messaging server software 124. In this implementation, plug-in 126 employs an index table 132 of a database 130 to store the location of file attachments and to identify attachments for retrieval. In one embodiment, index table 132 includes a Message ID column, an Attachment ID column, a Filename column, and Location column.

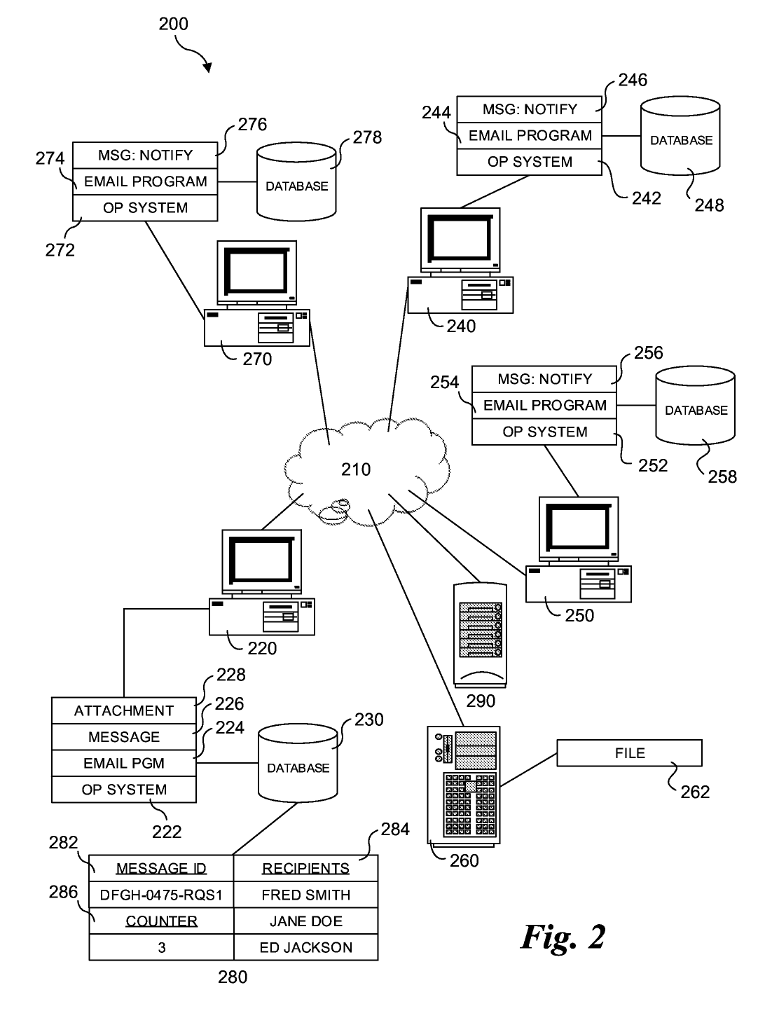

FIG. 2 shows a schematic diagram illustrating various aspects of a message attachment deletion system 200 that enables the deletion of a message with attachment on a plurality of computers to cause the deletion of a previously stored file attachment from a stored location. Message attachment deletion system 200 includes a network 210, which represents a Local Area Network (LAN), a Wide Area Network (WAN), the Internet, or some combination of the aforementioned networks. Message attachment deletion system 200 includes a client computer 220, from which an electronic mail message 224 with an attachment 228 is sent via an electronic mail program 224 running on an operating system 222. A database 230 is employed for storing and indexing various data relating to the processing of email attachments. Database 230 contains a message table 280, containing exemplary message ID 1082 “DFGH-0475-RQS1” with associated recipients 284 “Fred Smith, Jane Doe, Ed Jackson.” Attachment deletion system 200 also includes a client computer 270 with a message deletion message 276 generated by an electronic mail program 274 running on an operating system 272 and accessing a database 278. Similarly, a client computer 240 includes an operating system 242, an electronic mail program 244 which generates an attachment deletion message 246 and accesses a database 248; likewise, a client computer 250 includes an operating system 252, an electronic mail program 254 generating an attachment deletion message 256 and accessing a database 258. Message attachment deletion system 200 further includes a server computer 260 operating as a file and print server storing a file 262, which comprises the attachment pointed to by attachment 228 of message once stored to a network location. The system further includes a remote storage server 290 that is accessed via network 210 for the archiving of unused attachment files.

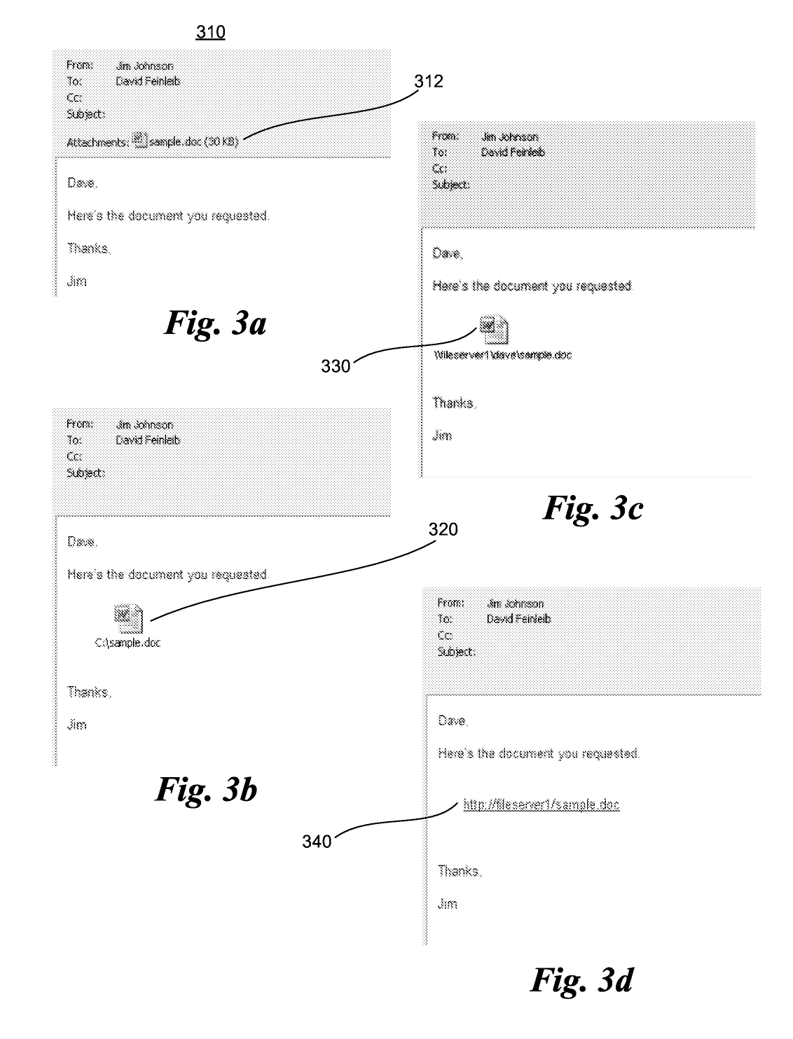

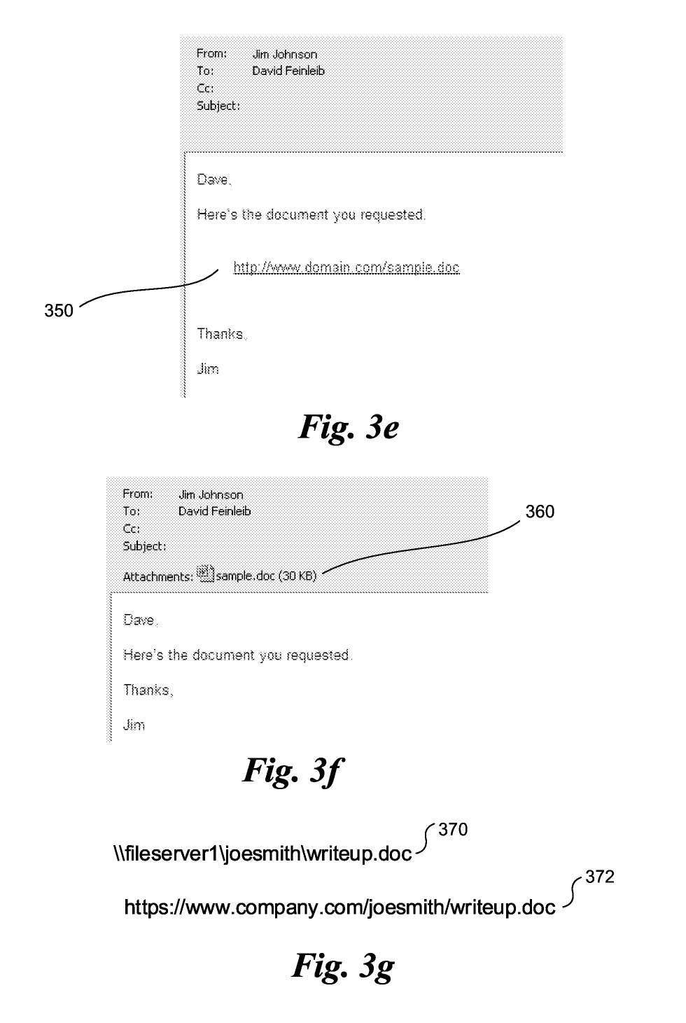

FIGS. 3a-e illustrate a plurality of exemplary email application user interface (UI) implementations for accessing stored file attachments in accordance with one embodiment. FIG. 3a shows an exemplary electronic mail message 310 with a file attachment “sample.doc” 312, corresponding to attachment 172t of the system architecture 100 of FIG. 1. Attachment 312 is shown as originally made available to the user in electronic mail application 114, prior to processing by plug-ins 116 or 126. Attachment 312 is stored locally on computer 110 in message storage file 146.

FIG. 3b shows a UI illustrating a link 320 pointing to stored file attachment 148 on local computer 110. A graphical icon representing file 148 is displayed as part of link 320. In one implementation, plug-in 116 replaces the actual attachment with link 320 and stores file attachment 172t to disk, as described in further detail below. In another implementation, plug-in 126 replaces the actual attachment with link 320 and stores file attachment 172t to disk, as also discussed below. When the user double-clicks on link 320, file “sample.doc” is opened, even though it is not stored in message file 146.

FIG. 3c shows a UI illustrating a Universal Naming Convention (UNC) pointer 330 to file attachment 152 on local file server 134. As will be described in further detail below, the storage of the file attachment and insertion of the pointer may be facilitated by either plug-in 116 or plug-in 126. When the user double-clicks on pointer 330, file “sample.doc” is retrieved; as with link 320 of FIG. 3b, the actual “sample.doc” file is not attached to the electronic mail message.

According to another approach, a Universe Resource Locator (URL) may be employed as a pointer to locate an attachment stored on a local or remote file system or accessed via the Internet. For example, under the approach shown in FIG. 3d, a file attachment corresponding to attachment 172t is replaced with a URL pointer 340 to file attachment 152 stored by plug-in 116 in one implementation, and plug-in 126 in another implementation, on local area network server 134 operating in file and web server roles. When the user double-clicks on pointer 340, file “sample.doc” is retrieved via the Hyper Text Transfer Protocol (HTTP) from server 134. In the example UI shown in FIG. 3e, a file attachment corresponding to attachment 172t replaced with a URL pointer 350 to file attachment 162, stored by plug-in 116 in one implementation and by plug-in 126 in another implementation, on web server 160. When the user double-clicks on pointer 350, file “sample.doc” is retrieved via the Hyper Text Transfer Protocol (HTTP) from web server 160.

FIG. 3f shows a UI illustrating a file attachment corresponding to attachment 172t, wherein the file attachment appears to the user to be stored in an attached document (“sample.doc”) in a manner similar to the conventional approach illustrated in FIG. 3a. In one implementation, as will be described later in more detail, plug-in 116 removes attachment 172t from message 170t and displays attachment 172t to the user when message 170t is opened by the user, and retrieves stored file attachment 148 from the disk of computer 110 or from file server 134, depending on where plug-in 116 was configured by the user to store file attachments. In an alternative implementation, electronic mail application 114 is implemented to store and retrieve file attachments outside message file 146, providing functionality similar to plug-in 116 but in an integrated fashion.

According to an aspect of some embodiments disclosed herein, a database is employed to facilitate multiple improvements over conventional e-mail systems. These benefits include a dramatic reduction in file storage requirements, reduction of limitations on where attachments may be stored, rapid retrieval of attachments, and grouping of attachments in a number of different ways.

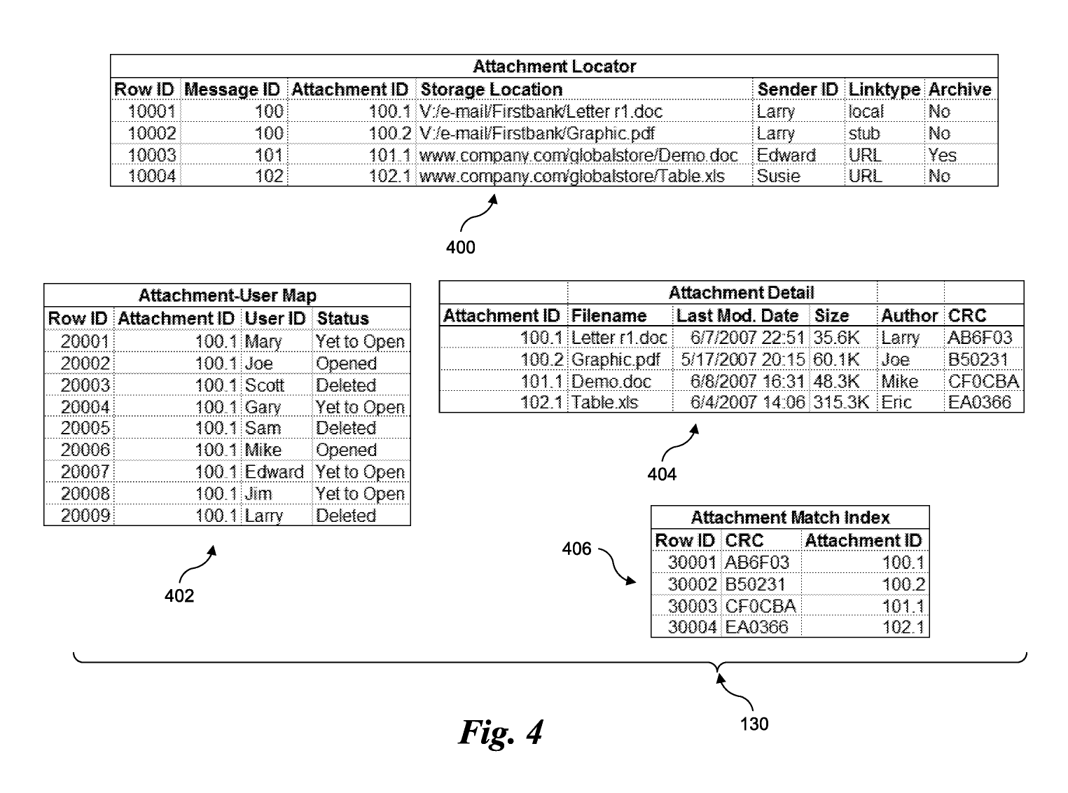

An exemplary data model corresponding to a portion of database 130 is shown in FIG. 4. The data model includes an Attachment Locator table 400, an Attachment-User Map table 402, an Attachment Detail table 404, and an Attachment Match Index table 406. The tables are illustrative of various message and attachment attributes that may be employed in an actual implementation of one or more of the embodiments discussed herein. As will be recognized by those skilled in the database arts, the illustrated tables are denormalized to make the related content of each table more clear. In an actual implementation, a normalized data model may be used, or a data model with selected denormalization may be deployed. It is further noted that a typical implementation may employ additional and/or augmented tables and indexes based on desired functionality and performance requirements. Additionally, surrogate keys, such as the Row ID columns may be implemented, as well as natural keys or the combination of the two.

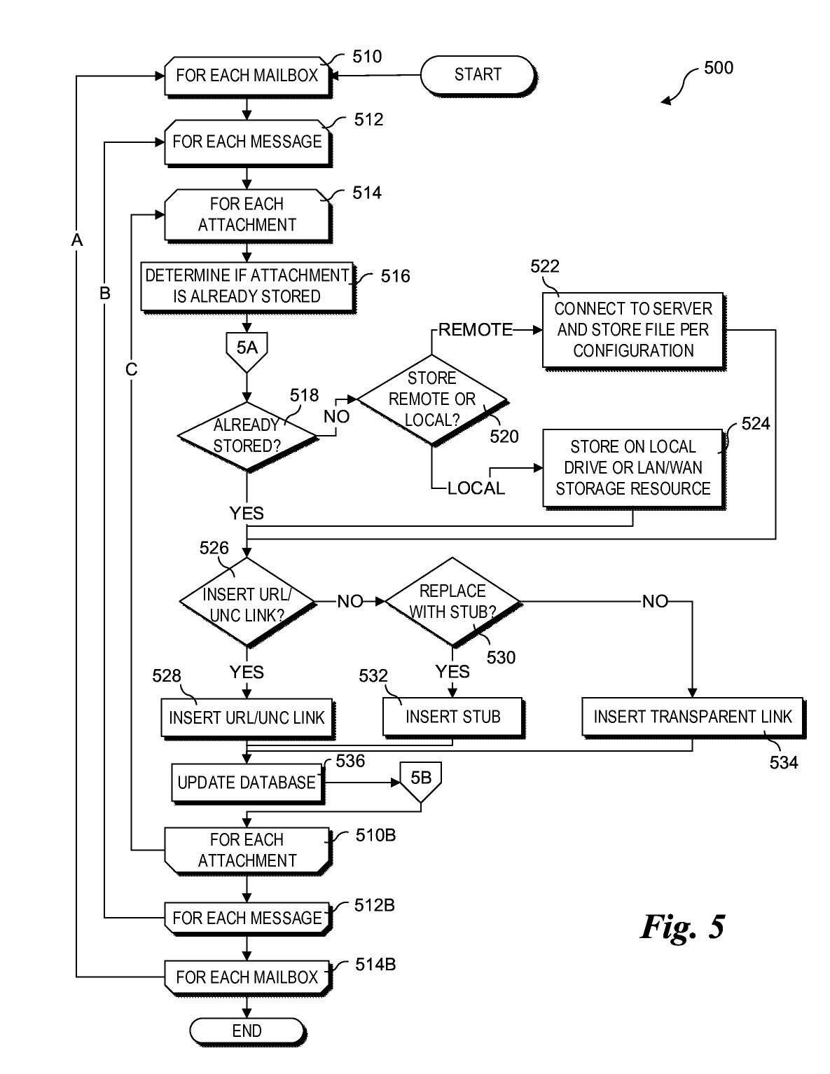

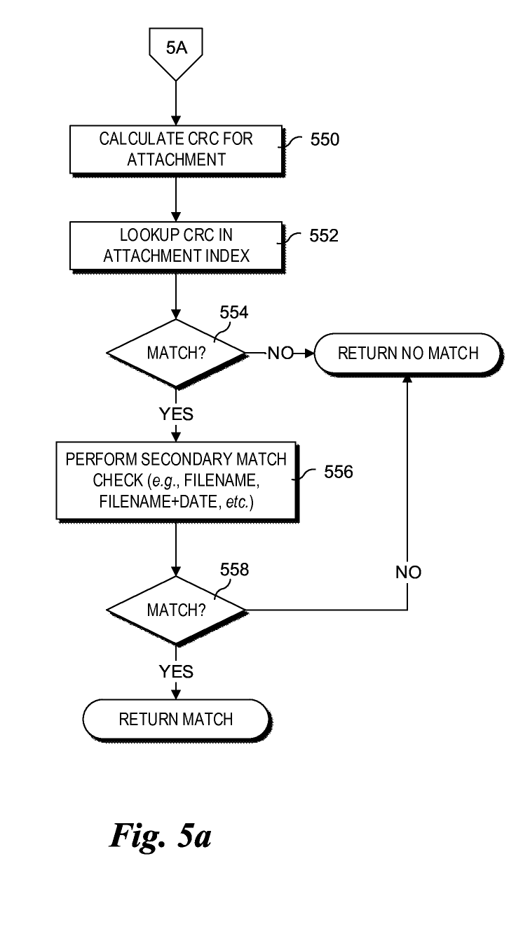

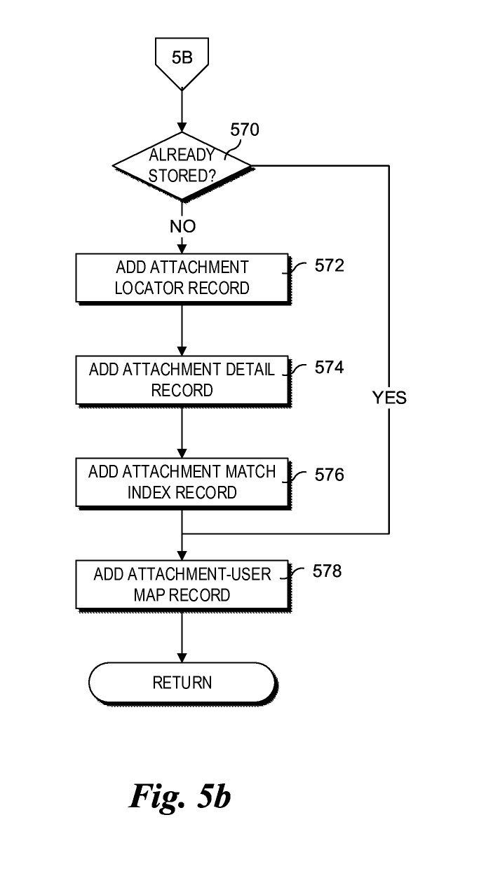

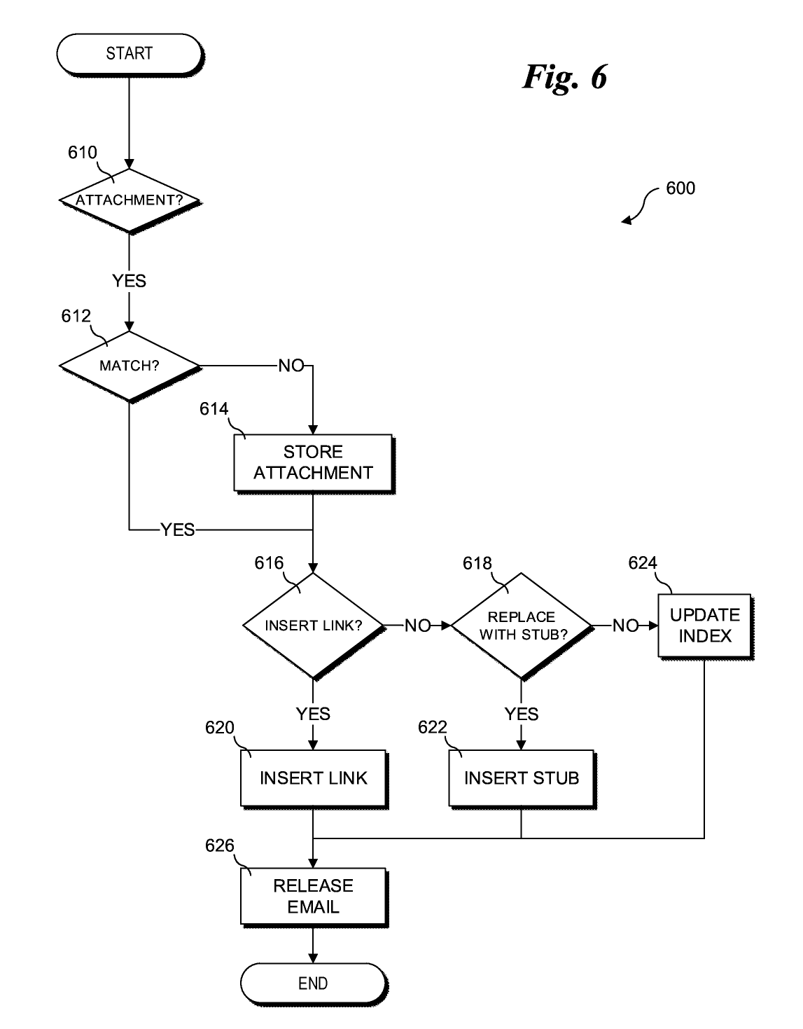

As shown in the flowchart 500 of FIG. 5 shows a flowchart 500 illustrating operation and logic performed by one embodiment of a server-based process for processing a plurality of electronic mail messages 174t-N, off-loading attachments 176t-N from the messages, and amending an individual message with a locator string that points to an on-disk or remote attachment location. In the illustrated embodiment, an asynchronous scheme is employed to process received messages, e.g., as a background task that may be performed in a periodic manner or as an ongoing process. As depicted by start and end loop block pairs 510A-B, 512A-B, and 514A-B forming nested loops A, B, and C, the following operations contained within loop C are performed for each attachment of each message in each of one or more mailboxes.

In start loop block 510, software plug-in 126 connects to Messaging Server Software 124 via Messaging Server Software API 128 and obtains the handle of the first mailbox in the system. In start loop block 512, plug-in 126 opens the first non-processed electronic mail message (that is, the first message that it has not previously processed as indicated by database 130). In connection with start loop block 514A, plug-in 126 determines if the message has a file attachment. If it does not, the logic returns to start loop block 512A to process the next message.

If the message contains one or more attachment, each attachment is processed in the following manner. First, the attachment is examined in a block 516, and a determination is made to whether an instance of the attachment is already stored at an on-disk location, a location on the local or wide area network, or on a server reachable via the Internet. In the general, the storage locations may be configured by the user and/or IT personnel and stored in database 130. Moreover, various techniques may be employed to verify the exact same file is currently stored, as compared with simply verifying a file with the same name is currently stored. For example, in one embodiment heuristics are employed to determine if a copy of the attachment already exists; depending on how the software has been configured, it may perform a timestamp, file size, and file name comparison, a cyclic redundancy check (CRC), or a combination of these checks. Details of one embodiment of this process are shown in FIG. 5a.

The process begins in a block 550, wherein a CRC is calculated for the attachment. Next, in a block 552 a lookup of an attachment index is performed to verify whether a CRC match exists. The attachment index is part of an e-mail database, and is used for performing rapid lookups of attachments to verify their existence. As shown in FIG. 4, the Attachment Index table 406 includes a CRC column and an attachment ID column, with the combination of the two columns forming the unique table key. The CRC column is indexed based on CRC values of previously processed attachments. If an e-mail with an identical attachment (to the current attachment) has been previously processed, a corresponding record will exist in Attachment Index table 406. A determination of whether a match exists is illustrated by a decision block 554. If no match exists, a no match result is returned to the flowchart of FIG. 5.

If decision block 554 indicates a match, further processing is performed to validate the match. The reason for this is that it is possible to have two different files with identical CRC values. In a block 556, a secondary match check is performed using the CRC match rows returned in block 552. For example, for each Attachment ID value, a lookup of Attachment Detail table 404 is performed. A comparison is then made between one or more attributes of the attachment file with corresponding attribute values in the Attachment Detail table. For example, the Filenames could be compared, a combination of the Filename and Create Date could be compared, etc. As depicted by a decision block 558, if a secondary match is found, a match result is returned to the flowchart of FIG. 5. If not, a no match result is returned.

Returning to FIG. 5, the result of the processing of FIG. 5a is depicted by a decision block 518. If the attachment is not already stored, then at a decision block 520 plug-in 126 determines if the user configuration indicates that attachments should be uploaded to a remote server (that is, a server located on the Internet) or be stored locally; if remote storage is configured, then the plug-in connects to the user-specified server using, in one embodiment, SSH File Transfer (SFTP) protocol, placing the file, block 522, in a subdirectory defined for the user, which can then be accessed by the user via the HTTPS protocol as shown in item 370 of FIG. 3g (e.g., the server is www.company.com; the user's name is joesmith; the stored attachment is writeup.doc). If, instead, plug-in 126 is configured to store the attachment to a local hard disk on server 120 or on a storage medium of another server accessible on the LAN or WAN, it does so in a block 524, using the standard file creation and saving functions provided by the applicable host operating system for host server. In addition, attachment files may be stored on other local resources, such as a network attached storage (NAS) appliance or the like using well-known protocols and techniques.

With the attachment now stored, the process continues. Plug-in 126 supports a plurality of mechanisms for making the attachment accessible to the user, based on how the user has configured the plug-in. If plug-in 126 is configured to remove message attachments and insert a URL or UNC link (as previously described), as depicted by a decision block 426, then it does so, in a block 428: if the attachment is stored locally, plug-in 126 inserts a text string containing a Universal Naming Convention (UNC) pointer 330; if the attachment is to be stored remotely, a Universal Resource Locator (URL) pointer 350 is inserted, wherein the pointer may be employed to access the attachment over the Internet via the Hypertext Transfer Protocol or the HyperText Transfer Protocol over SSL (HTTPS). The file attachment may then be accessed by a user by clicking on the text string now in the message, or by going to the location of the file on the network via the file browsing mechanism of operating system 122 in the case of UNC 330, or via a web browser, such as but not limited to Internet Explorer (e.g., IE 8, 9, or 10) Google Chrome, Firefox, Apple Safari, or Opera, in the case of URL 350. In addition, mobile clients may use mobile web browser such as Apple Mobile Safari, Google Android Browser, Google Chrome, Internet Explorer for Window Phone OS, Opera Mobile, and Firefox Mobile.

If not configured to insert a link, plug-in 126 determines if it is configured to replace the attachment with a stub file, known as a shortcut, that points to the on-disk location of the attachment, as depicted by a decision block 530 and a block 532. If plug-in 126 is not configured to insert a stub, in a block 534 it inserts a transparent link in the message that functions as a pointer to an applicable index table in database 130. In this case, the attachment is no longer stored in the message, but its location is indicated by a separate index table entry. For example, a separate entry may be added to Attachment Locator table 400 or to an attachment index pointer table (not shown).

After performing one of the operations of blocks 528, 532, or 534, the logic proceeds to a block 536 in which the database 130 is updated to reflect the storage location of the file and the instance of the file, as applicable. Details of one embodiment of this process are shown in FIG. 4b and described below. Upon completion of the processing of the current attachment, the logic loops back to begin processing the next attachment (should one exist), or the next message if the last attachment has been processed. As discussed above, the overall process is repeated for each message of each mailbox configured by the user or an administrator to be processed.

The process begins in a decision block 570, wherein a determination is made to whether the attachment was already stored previously. This is the same result as decision block 518 of FIG. 5. If it is a new attachment, a new record is created in a block 572 that includes a reference to a new attachment and its location in Attachment Locator table 400. As shown in the example Attachment Locator table 400 of FIG. 4, the new entry will include an automatically-generated Row ID, an automatically-generated Message ID, an Attachment ID (which in the illustrated example is the Message ID plus a “.” Followed by an attachment number. A value identifying the storage location is stored in the Storage Locator column, and an identity of the sender is stored in a Sender ID column. The Linktype column is used to identify the type of link used, e.g., a local transparent link, a stub, a URL, or a UNC. The Archive column is used to indicate whether or not the attachment is archived.

Next, an attributes relating to details of the attachment are entered in Attachment Detail table 404 in a block 574. In the illustrated example, these include an Attachment ID value uniquely identifying the attachment, a Filename, a Last (Mod)ified Date, a Size, an Author, and a CRC value.

As discussed above, in some implementations it will be desired to rapidly determine whether an instance of an attachment is already stored or otherwise has been previously located by the e-mail system. Accordingly, in one embodiment a CRC for the attachment is calculated and a corresponding record is added to Attachment Match Index table 406 in a block 576.

Whether the attachment is a new instance of an existing attachment or a new attachment, a new record is added to Attachment-User Map Table 402 creating a mapping linking the attachment to each user that received the attachment in the message. In one embodiment a Status column value is also entered (initially set to “Yet to Open”); further details of the purpose of the Status column are discussed below in the context of archiving attachments.

In an alternative embodiment illustrated by flowchart 500 of FIG. 5, software plug-in 116 running in electronic mail application 114 processes electronic mail messages 170t-N by running on client computer 110, rather than on server computer 120. The instant embodiment is advantageous in the scenario where the user would like the benefits of server plug-in 126 but does not have access to run plug-in 126 on server computer 120 (for example, due to administrative restrictions of an information technology department). In this embodiment, plug-in 116 first determines if it has been configured by the user at a decision block 510; if it has not been configured, it presents a dialog box to the user (block 512) in which the user can enter configuration information that tells the plug-in how to handle message attachments (that is, whether to save them to local disk, a remote server, or both).

In a block 514, plug-in 116 obtains a handle to the first message in the user's mailbox, stored on client computer 110 in message file 146, and a determination is made in a decision block 516 to whether the message has one or more attachments 172t-N. If it determines that the message has one or more attachments, it gets each of attachments 172t-N, at a block 518, storing into memory the attachment name and date. It then looks in a binary index file to determine if the attachment has already been stored to disk; that is, it searches the index file for the attachment name and date and determines if the attachments appears already to have been stored; if a match is found in the index file, the plug-in calculates a 16 bit Cyclic Redundancy Check (CRC) for the attachment and evaluates whether the CRC value for the attachment is the same as the one stored in the index file for the attachment that it has determined may already been stored on disk; if one or more of the attachments do not already exist on disk, it stores the attachment(s) to disk at a location specified by the user during step 512; it then removes the attachments from the electronic mail message and follows the steps of sub-routine 480 of FIG. 4, to insert a text string containing a URL or UNC value, a stub, or it updates index file 142 (rather than database 130). Finally, it determines if there are more unprocessed messages, decision point 522; if there are, the plug-in retrieves the next message, step 524, and repeats the loop until there are no more messages.

In another alternative embodiment, FIG. 6 drawing 600, software plug-in 126 running on server computer 120 performs inline processing of electronic mail messages; that is, rather than operating as an out-of-band process it processes each message before the message is made available to a user. Moreover, in this alternative embodiment, plug-in 126 supports inserting a URL or UNC link, as previously described, inserting a stub, or simply updating an index, so that, as will be described later, plug-in 126 can hook the attachment retrieval and return an attachment, even though such attachment was not stored in messaging server 124.

In step 610, plug-in 126 running on server computer 120 processes an individual electronic mail message as it is received and determines whether it has an attachment. As previously described, the plug-in uses a plurality of heuristics to determine if there is a matching file already stored, decision point 612; if there isn't, plug-in 126 stores the attachment to disk, step 614. Plug-in 126 supports a plurality of mechanisms for making the attachment accessible to the user, based on how the user has configured the plug-in. If plug-in 126 is configured to remove message attachments and insert a URL or UNC link (as previously described), decision point 616, then it does so, step 620. If not, plug-in 126 determines if it is configured to replace the attachment with a stub file that points to the on-disk location of the attachment, decision point 618. If plug-in 126 is not configured to insert a stub, it updates SQL database 130 index table 132. In this way, the attachment is no longer stored in the message, but its location is indicated by separate index table 132. In step 624, the electronic mail message is released from processing by plug-in 126. The plug-in carries out the aforementioned steps for each attachment and electronic mail message.

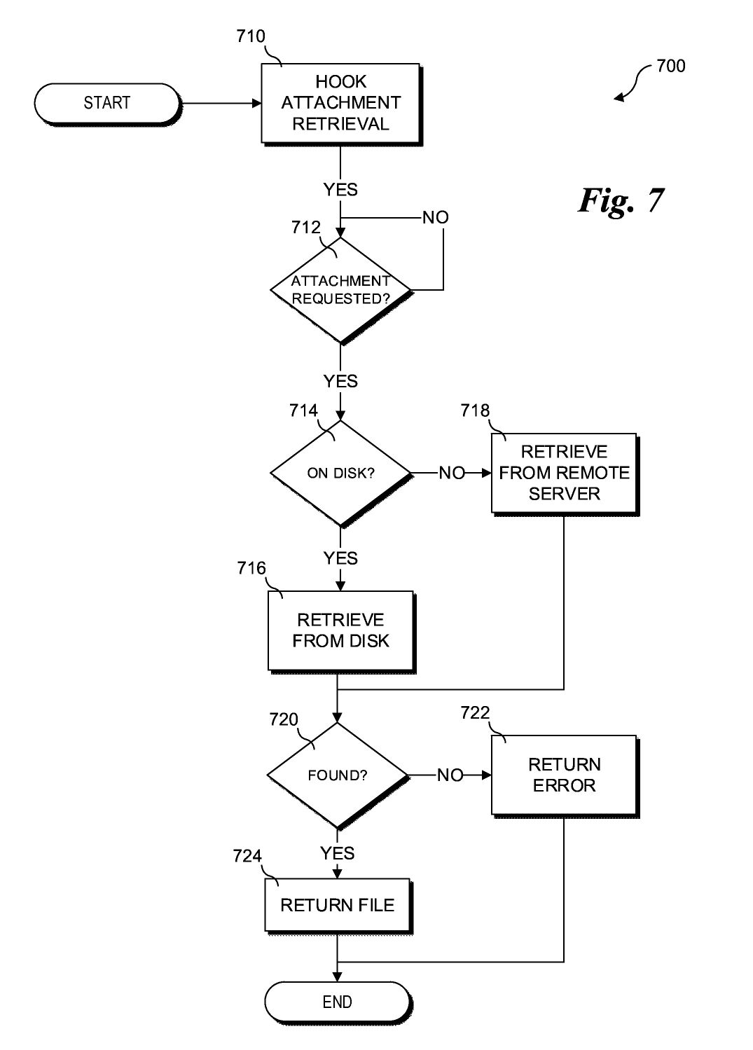

Process 700 of FIG. 7 illustrates a server-based embodiment in which an attachment is later retrieved and served up to the user when requested. In step 710, plug-in 126 inserts itself as a hook so that when an attachment is requested, plug-in 126 has an opportunity to return the attachment rather than the attachment being returned by electronic messaging software 124. Plug-in 126 then remains in a waiting mode until an attachment is requested, decision point 712.

If an attachment is requested, plug-in 126 retrieves it from disk by searching in index table 132 for the location of the attachment. At decision point 714, plug-in 126 determines, based on the information contained in table 132, whether the attachment is stored on disk or remotely. If it is stored remotely, then in one implementation, plug-in 126 retrieves the attachment from remote server 134 over a Virtual Private Network (VPN) connection. Otherwise, in step 716 plug-in 126 retrieves the attachment file from local disk on server 120. If the file is not found, decision point 720, an error code is returned, indicating a failure to find the file; otherwise the file is returned. Plug-in 126 remains resident with messaging server 124 to handle future attachment retrieval requests.

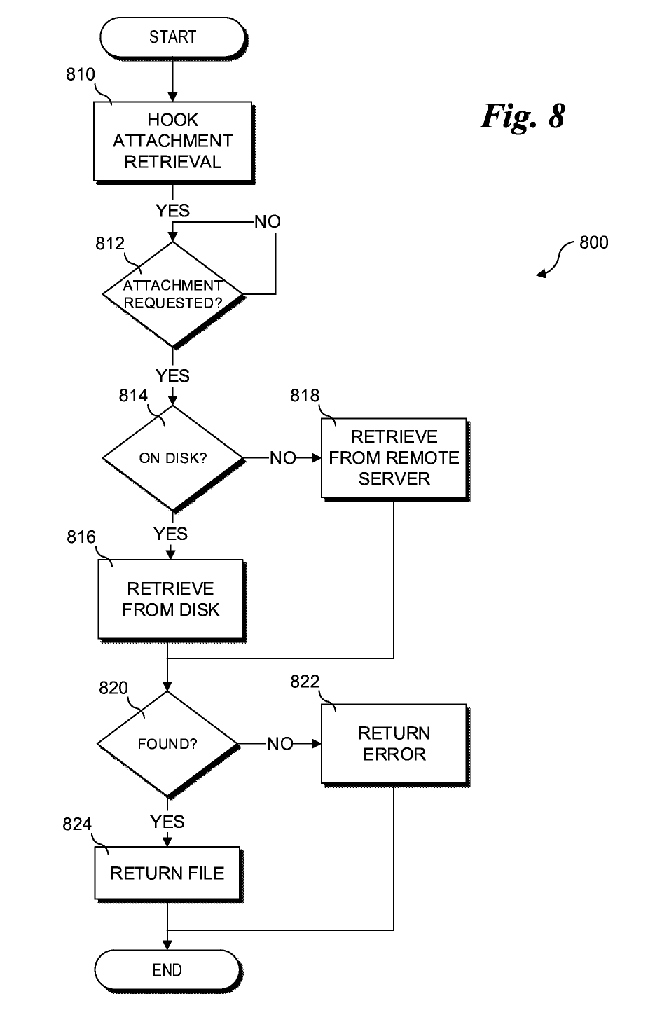

In an alternative embodiment, FIG. 8, drawing 800, plug-in 116 runs on client computer 110 in electronic messaging application 114. In step 810, plug-in 116 inserts itself as a hook so that when an attachment is requested, the plug-in has an opportunity to return the attachment rather than the attachment being returned by electronic messaging application 114. Plug-in 116 remains in a waiting mode until an attachment is requested, decision point 812. If an attachment is requested, it is retrieved from disk by searching in index file 142 for the location of the attachment. At decision point 814, plug-in 116 determines, based on the information contained in index file 142, whether the attachment is stored on disk or remotely. If it is stored remotely, plug-in 116 retrieves the attachment from remote server 160 over a Secure Sockets Layer (SSL) connection over the Internet. Otherwise, in step 816, plug-in 116 retrieves the attachment file from local disk on computer 110. If the file is not found, decision point 820, an error code is returned, indicating a failure to find the file; otherwise the file is returned. Plug-in 116 remains resident with messaging application 114 to handle future attachment retrieval requests.

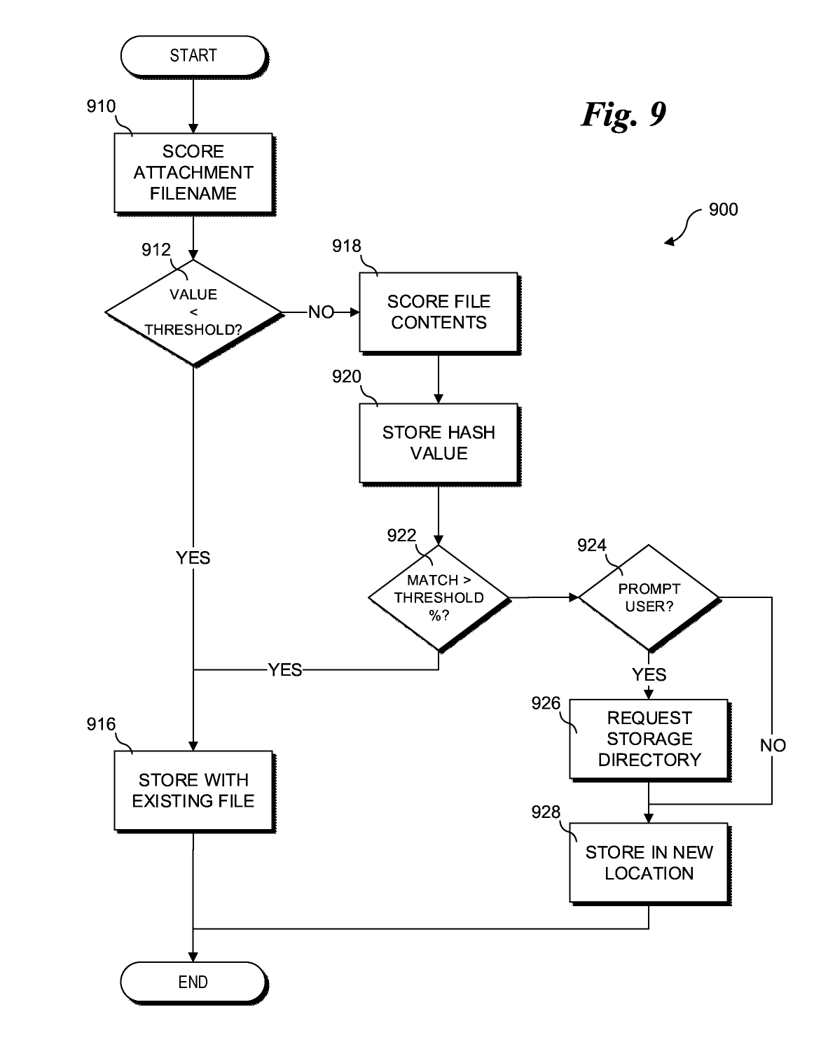

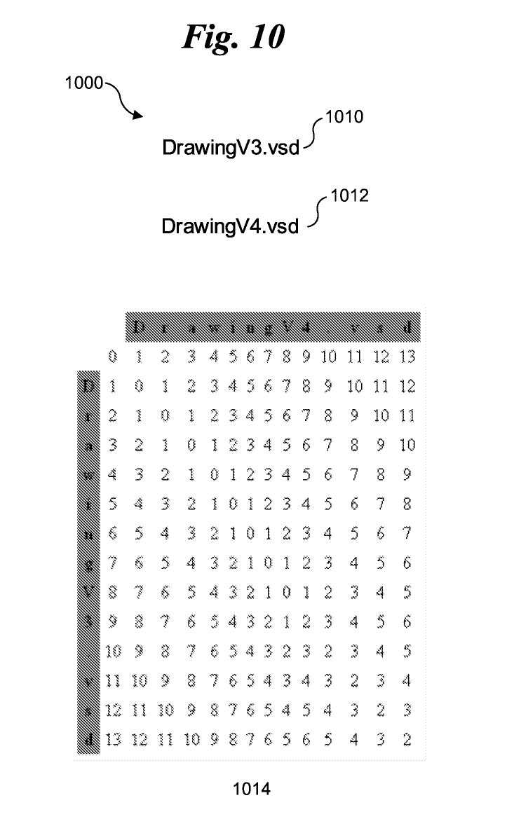

In FIG. 9 drawing 900 a process flow is described for software plug-in 116 for comparing newly received attachment files to existing stored attachment files so that newly received attachments can, when stored, be logically grouped with existing attachments when possible to do so. When the user of an electronic mail application receives numerous attachments, recognizing related attachments and storing them together can become cumbersome; the process flow described in FIG. 9 addresses this issue. In drawing 900 an attachment in an electronic mail message has been retrieved and is being processed by plug-in 116, when in step 910 plug-in 116 scores the attachment filename against all other attachments that have previously been stored using the Levenshtein edit distance algorithm, an algorithm that is familiar to one skilled in the art. If the computed edit distance 1014 in drawing 1000 FIG. 10 is less than the configured threshold value; that is, if an existing file is found that has filename 1010 that is highly similar to filename 1012 of the file attachment being processed, then the file attachment is stored in the same directory as the matching file.

Alternatively, if there is no match that is below the set threshold, then the contents of the file attachment are scored by creating a hash table 144 from the words, step 918, and storing the resulting hash value in hash table 144, step 920. Then plug-in 114 determines by evaluating hash table 144 if there is a high probability that the contents of the file are similar to the hash value of the words of an existing file, using a Bayesian comparison algorithm, an algorithm that is familiar to one skilled in the art, decision point 922.

As with decision point 912, if there is a match, the attachment is stored in the same sub-directory as the existing file, step 916. If there is no match, plug-in 114 determines whether to display a dialog box prompting the user for a storage location for the file, decision point 924; if the user is to be prompted (based on user configuration) then a dialog box is displayed, step 926, and the user-specified location accepted. In step 928 the file attachment is stored to the new location, and the process completes.

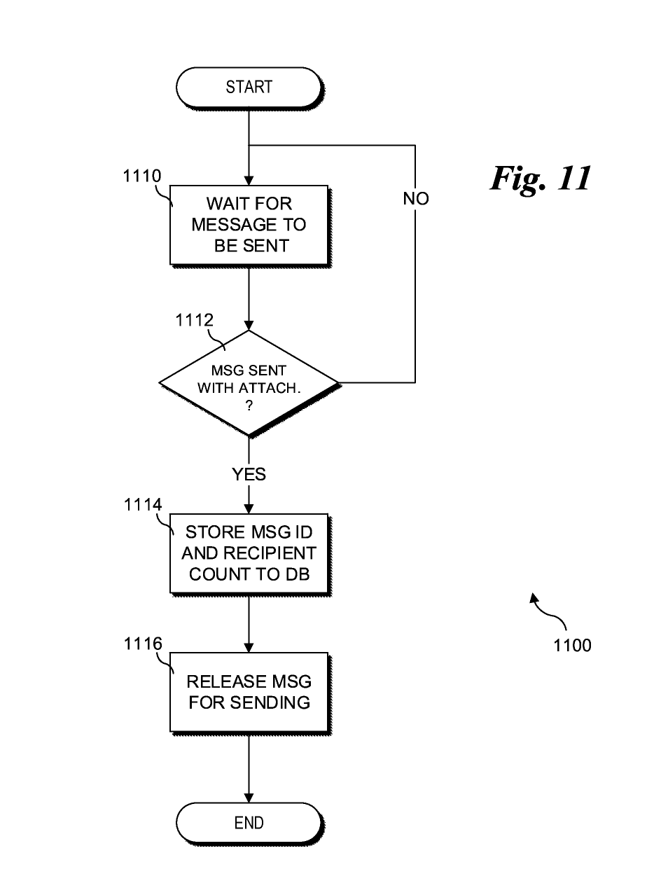

FIG. 11 is a drawing 1100 of a flowchart illustrating the process for detecting the transmission of a message with attachment and the storing of an associated message ID 282 and recipient counter 286 to a database. In step 1110, electronic mail program 224 waits for an electronic mail message to be sent by the user. If a message 224 is sent with an attachment 228 (decision point 1112), electronic mail program 224 creates unique message ID 282 and stores it and the list of recipients 284 of message 226 to database 230. Electronic mail program 224 then releases the message for sending. Like electronic messaging program 224, messaging programs 244, 254, and 274 can follow the aforementioned steps to record the transmission of a message with attachment with recipient list and message ID to databases 248, 258, and 278 respectively.

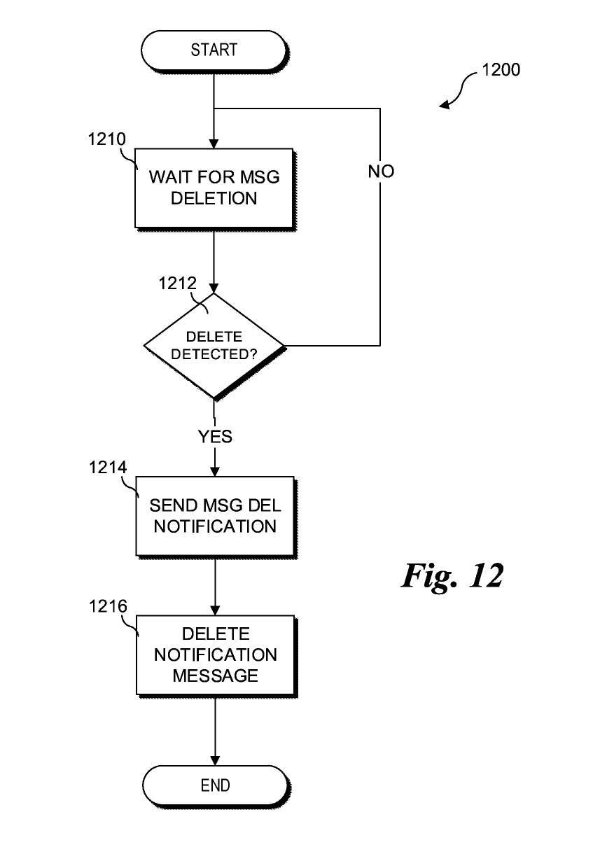

FIG. 12 is a drawing 1200 of a flowchart illustrating the process for detecting the deletion of a message with an attachment and the corresponding notification to a message sender indicating the message deletion. In step 1210, electronic message programs 244, 254, and 274 wait for a message to be deleted by the users of computers 240, 250, and 270, respectively. If electronic message program 244 detects the deletion of a message with an attachment (decision point 1212), then program 244 creates attachment deletion message 246 and sends, step 1214, attachment deletion message 246 to the original sender of the message, that is, the user of electronic messaging program 224. Program 244 then deletes attachment deletion message 246 from the list of sent messages, step 1216. The same process occurs on computer 250 with messaging program 254 and attachment deletion message 256; and on computer 270 with messaging program 274 and attachment deletion message 276.

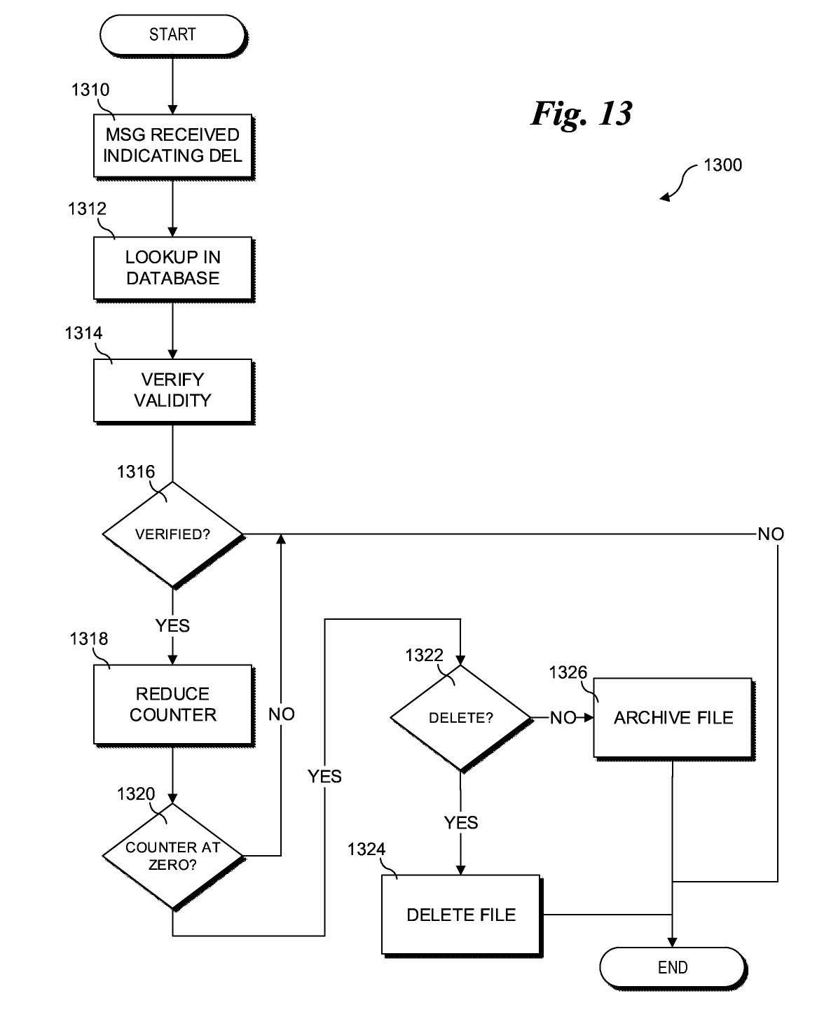

FIG. 13 is a drawing 1300 of a flowchart illustrating the receiving of an attachment deletion notification message, the processing and verification of said message, and the deletion of a file if indicated. In step 1310, attachment deletion message 246, 256, or 276 is received by program 224 containing a unique message ID, which program 224 looks up in database 230, step 1312. In step 1314, message program 224 verifies the validity of the received message; if the message is verified (decision point 1316), program 224 reduces counter 286 associated with the message ID, stored in database 230, step 1318. Program 224 determines if counter 286 is at zero (decision point 1320), indicating that there are no remaining instances of the attachment pointed to by any recipients, and if so, program 224 determines if the file is to be deleted or archived (decision point 1322). If deleted, program 224 deletes file 262 (formerly attachment 228) from server 260 via network 210, step 1324; if the file is to be archived, it is moved to remote archive storage server 290, step 1326. In this way, if all occurrences of a message pointing to an attachment are deleted, then the attachment itself is automatically deleted, freeing up critical disk space, a unique benefit of the present invention.

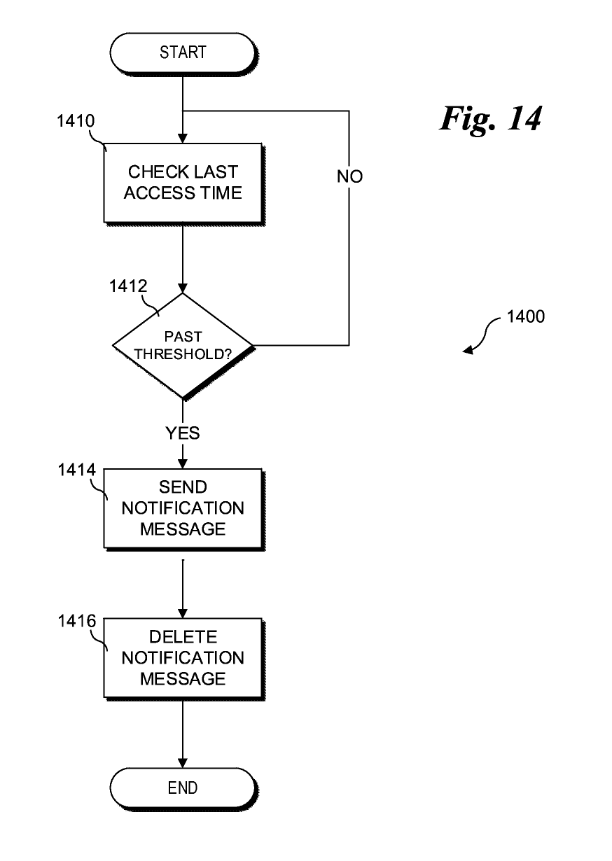

FIG. 14 is a drawing 1400 of a flowchart illustrating the process for determining if a message pointing to a file attachment has not been recently accessed by a message recipient, and then sending a message notifying the sending system of non-access, causing the archiving of the attachment. In step 1410, electronic messaging programs 244, 254, and 274 run a daily process, scanning through each electronic mail message to determine the last time each message was accessed by the user. If on computer 240, the access time for any particular message is beyond the threshold for access time (e.g. a user-configured threshold such as 90 days) (decision point 1412), then program 244 creates attachment notification message 246 indicating threshold expiration, and, step 1414, sends attachment notification message 246 to the sender of the message, that is, the user of electronic messaging program 224. Program 244 then deletes attachment notification message 246 from the list of sent messages, step 1416. The same process occurs on computer 250 with messaging program 254 and attachment notification message 256; and on computer 270 with messaging program 274 and attachment notification message 276. The result is that program 224 receives the message, as described in drawing 1300, and archives file 262 to remote archive storage server 290 over network 210.

### Exemplary Implementation Environment and Blade Server Architecture

It is envisioned that aspects of the embodiments herein may be implemented in various types of computing environments, including on-premise equipment such as computers and servers communicatively coupled via a LAN, as well as blade servers and modules employed in a data center and/or server farm environment. Typically, the servers used in data centers and server farms comprise arrayed server configurations such as rack-based servers including multiple server blades or modules. These servers are interconnected in communication via various network provisions, such as partitioning sets of servers into LANs with appropriate switching and routing facilities between the LANs to form a private Intranet. For example, cloud hosting facilities may typically employ large data centers with a multitude of servers.

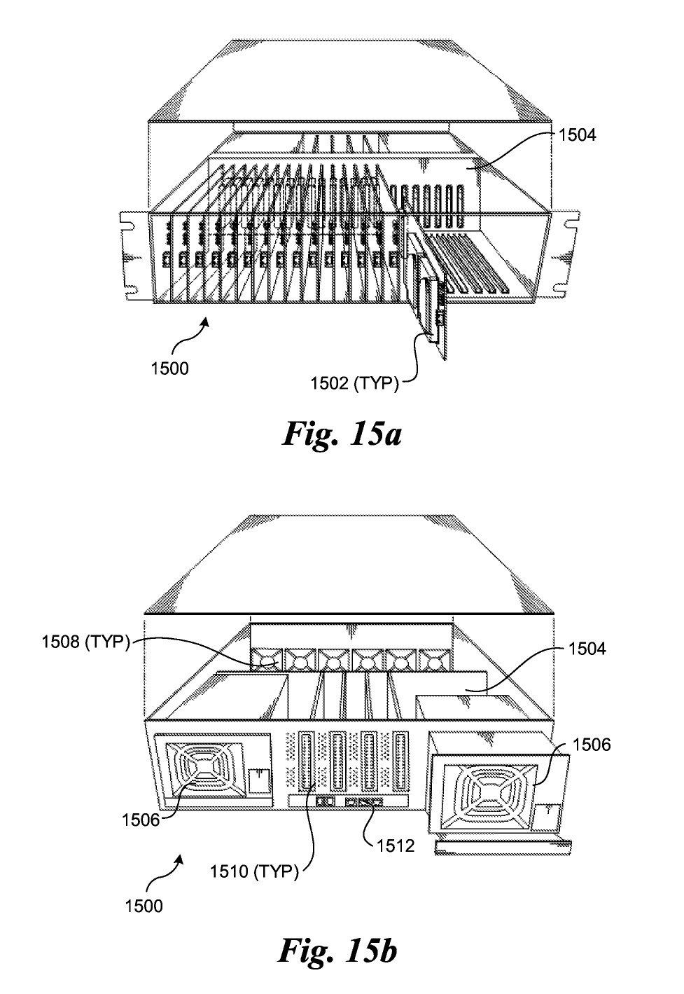

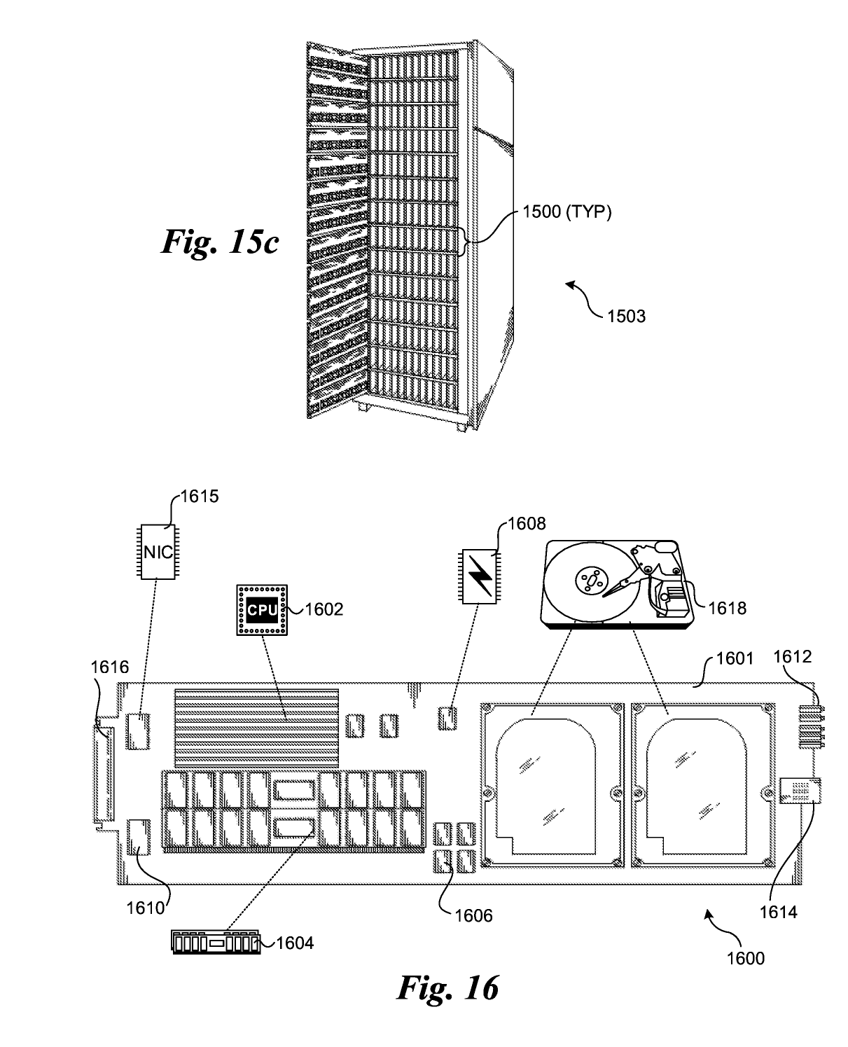

As an overview, typical blade server components and systems are shown in FIGS. 15a-c, and 16. Under a typical configuration, a rack-mounted chassis 1500 is employed to provide power and communication functions for a plurality of server blades (i.e., blades) 1502, each of which occupies a corresponding slot. (It is noted that all slots in a chassis do not need to be occupied.) In turn, one or more chassis 1500 may be installed in a blade server rack 1503 shown in FIG. 15c. Each blade is coupled to an interface plane 1504 (e.g., a backplane or mid-plane) upon installation via one or more mating connectors. Typically, the interface plane will include a plurality of respective mating connectors that provide power and communication signals to the blades. Under current practices, many interface planes provide “hot-swapping” functionality—that is, blades can be added or removed (“hot-swapped”) on the fly, without taking the entire chassis down through appropriate power and data signal buffering.

A typical mid-plane interface plane configuration is shown in FIGS. 15a and 15b. The backside of interface plane 1504 is coupled to one or more power supplies 1506. Oftentimes, the power supplies are redundant and hot-swappable, being coupled to appropriate power planes and conditioning circuitry to enable continued operation in the event of a power supply failure. In an optional configuration, an array of power supplies may be used to supply power to an entire rack of blades, wherein there is not a one-to-one power supply-to-chassis correspondence. A plurality of cooling fans 1508 are employed to draw air through the chassis to cool the server blades.

An important feature required of all blade servers is the ability to communicate externally with other IT infrastructure. This is typically facilitated via one or more network connect cards 1510, each of which is coupled to interface plane 1504. Generally, a network connect card may include a physical interface comprising a plurality of network port connections (e.g., RJ-45 ports), or may comprise a high-density connector designed to directly connect to a network device, such as a network switch, hub, or router.

Blade servers usually provide some type of management interface for managing operations of the individual blades. This may generally be facilitated by a built-in network or communication channel or channels. For example, one or more buses for facilitating a “private” or “management” network and appropriate switching may be built into the interface plane, or a private network may be implemented through closely-coupled network cabling and a network. Optionally, the switching and other management functionality may be provided by a management switch card 1512 that is coupled to the backside or front-side of the interface plane. As yet another option, a management or configuration server may be employed to manage blade activities, wherein communications are handled via standard computer networking infrastructure, for example, Ethernet.

With reference to FIG. 16, further details of an exemplary blade 1600 are shown. As discussed above, each blade comprises a separate computing platform that is configured to perform server-type functions, i.e., is a “server on a card.” Accordingly, each blade includes components common to conventional servers, including a main printed circuit board (main board) 1601 providing internal wiring (i.e., buses) for coupling appropriate integrated circuits (ICs) and other components mounted to the board. These components include one or more processors 1602 coupled to system memory 1604 (e.g., some form of Random Access Memory (RAM)), cache memory 1606 (e.g., SDRAM), and a firmware storage device 1608 (e.g., flash memory). A NIC (network interface controller) chip 1610 is provided for supporting conventional network communication functions, such as to support communication between a blade and external network infrastructure. Other illustrated components include status LED (light-emitting diodes) 1612, a set of RJ-45 console ports 1614 (only one of which is shown for simplicity), and a NIC 1615 coupled to an interface plane connector 1616. Additional components include various passive components (i.e., resistors, capacitors), power conditioning components, and peripheral device connectors. Processor 1602 may typically comprise a multi-core processor having a System on aChip (SoC) architecture.

Generally, each blade 1600 may also provide on-board storage. This is typically facilitated via one or more built-in disk controllers and corresponding connectors to which one or more disk drives 1618 are coupled. For example, typical disk controllers include SATA controllers, SCSI controllers, and the like. As an option, the disk drives may be housed separate from the blades in the same or a separate rack, such as might be the case when a network-attached storage (NAS) appliance or backend storage sub-system that is employed for storing large volumes of data. Disk drives 1618 may be Solid State Drives (SSDs), magnetic drives or optical drives. Optionally, other types of solid state mass storage devices may be used.

In a typical data center deployment, network switching elements comprise rack-mounted equipment, such as would occupy a 1U, 2U, or 4U slot, or may be implemented via one or more server blades. Optionally, a network switching element may be implemented use one or more server blades.

### Exemplary User Equipment

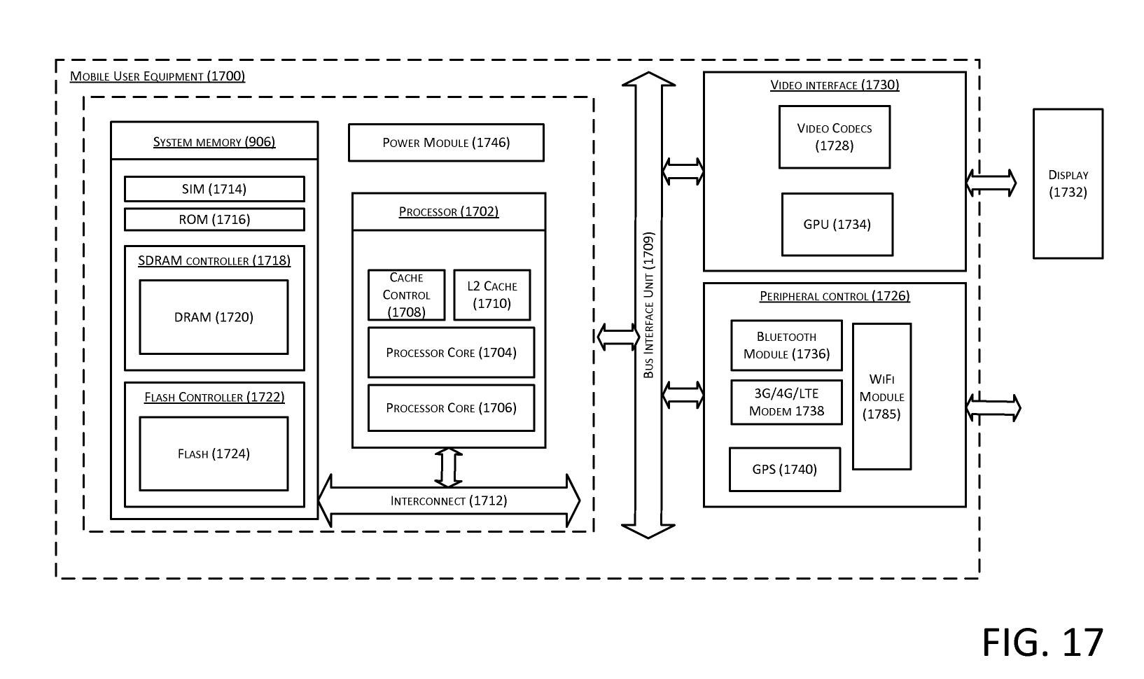

Turning next to FIG. 17, an embodiment of mobile user equipment (UE) 1700 employing a processor 1702 employing a system on a chip (SOC) architecture that may be implemented for hosting an e-mail client in various types of computing devices and platforms is depicted. In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station in a mobile network.

As a specific illustrative example, processor 1702 includes an Intel® Architecture Core™-based processor such as an i3, i5, i7 or another such processor available from Intel Corporation, Santa Clara, Calif. However, it will be understood that other low power processors such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters may instead be present in other embodiments such as an Apple A6/A7 processor, a Qualcomm Snapdragon processor, or TI OMAP processor. Note that many of the customer versions of such processors are modified and varied; however, they may support or recognize a specific instructions set that performs defined algorithms as set forth by the processor licensor. Here, the micro-architectural implementation may vary, but the architectural function of the processor is usually consistent. Certain details regarding the architecture and operation of processor 1702 in one implementation will be discussed further below to provide an illustrative example.

For illustrative purposes, processor 1702 is depicted as including two cores 1704 and 1706; however, a processor may generally include one or more cores. Generally, cores 1704 and 1706 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1704 and 1706 are coupled to cache control 1708 that is associated with bus interface unit 1709 and L2 cache 1710 to communicate with other parts of processor 1702. Interconnect 1712 comprises an on-chip interconnect, such an Intel® QuickPath Interconnect (QPI) or Keizer Technology Interconnect (KTI), an Intel® On-chip System Fabric (IOSF), an Advanced Microcontroller Bus Architecture (AMBA) interconnect, a multi-dimensional mesh fabric, or other known interconnect architecture. Generally, interconnect 1712 may be configured in a variety of different manners, including a mesh, ring, or torus configuration. Interconnect 1712 is also illustrative of an interconnect hierarchy, and may include more than one interconnect architecture under which different levels in the interconnect hierarchy are connected via applicable bridges. For example, a portion of interconnect 1712 may comprise a Peripheral Component Interconnect Express (PCie™) interconnect hierarchy.

Interconnect 1712 provides communication channels to other system components, such as a Subscriber Identity Module (SIM) 1714 to interface with a SIM card (not shown), a boot ROM 1716 to hold boot code for execution by one or more of cores 1704 and 1706 to initialize and boot processor 1702, a SDRAM controller 1718 to interface with external memory (e.g. DRAM 1720), a flash controller 1722 to interface with non-volatile memory (e.g., Flash 1724), a peripheral control 1726 (e.g., Serial Peripheral Interface) to interface with peripherals, video codecs 1728 and Video interface 1730 to display on and receive input (e.g., touch enabled input) from a touchscreen display 1732, and a GPU 1734 to perform graphics related computations, etc.

In addition, UE 1700 may include one or more peripherals for communication, such as a Bluetooth module 1736, 3G/4G/LTE modem 1738, GPS 1740, and WiFi module 1785, which supports Wi-Fi™ communications in accordance with a given Institute of Electrical and Electronics Engineers (IEEE) 802.11 standard (e.g., one or more of 802.11a, b, g, and n). Integrated antenna support can be provided for WiFi™, Bluetooth, and GPS.

A power control module 1746 is configured to supply and control power input to processor 1702 and other system components. Power control in the processor can lead to enhanced power savings. For example, power can be dynamically allocate between cores, individual cores can change frequency/voltage, and multiple deep low power states can be provided to enable very low power consumption. In addition, dynamic control of the cores or independent core portions can provide for reduced power consumption by powering off components when they are not being used.

In some embodiments, touchscreen display 1732 may comprise a display panel that may operate in multiple modes. In a first mode, the display panel can be arranged in a transparent state in which the display panel is transparent to visible light. In various embodiments, the majority of the display panel may be a display except for a bezel around the periphery. When the system is operated in a notebook mode and the display panel is operated in a transparent state, a user may view information that is presented on the display panel while also being able to view objects behind the display. In addition, information displayed on the display panel may be viewed by a user positioned behind the display. Or the operating state of the display panel can be an opaque state in which visible light does not transmit through the display panel.

In a tablet mode the system is folded shut such that the back display surface of the display panel comes to rest in a position such that it faces outwardly towards a user, when the bottom surface of the base panel is rested on a surface or held by the user. In the tablet mode of operation, the back display surface performs the role of a display and user interface, as this surface may have touch screen functionality and may perform other known functions of a conventional touch screen device, such as a tablet device. To this end, the display panel may include a transparency-adjusting layer that is disposed between a touch screen layer and a front display surface. In some embodiments the transparency-adjusting layer may be an electrochromic layer (EC), a LCD layer, or a combination of EC and LCD layers.

In various embodiments, the display can be of different sizes, e.g., an 11.6″ or a 13.3″ screen, and may have a 16:9 aspect ratio, and at least 300 nits brightness. Also the display may be of full high definition (HD) resolution (at least 1920×1080p), be compatible with an embedded display port (eDP), and be a low power panel with panel self refresh.

UE 1700 may also be configured as a tablet having a top surface comprising touchscreen display 1732. The display area of touchscreen display 1732 may be one of many existing or future sizes and resolutions, such as 6″, 7″, 7.7″, 8″, 8.9″, 10″, 10.1″, etc., with resolutions including but not limited to 1024×768, 1280×720, 1920×1080, 2048×1536, and 2560×1600.

As to touch screen capabilities, the system may provide for a display multi-touch panel that is multi-touch capacitive and being at least 5 finger capable. And in some embodiments, the display may be 10 finger capable. In one embodiment, the touch screen is accommodated within a damage and scratch-resistant glass and coating (e.g., Gorilla Glass™ or Gorilla Glass 2™) for low friction to reduce “finger burn” and avoid “finger skipping”. To provide for an enhanced touch experience and responsiveness, the touch panel, in some implementations, has multi-touch functionality, such as less than 2 frames (30 Hz) per static view during pinch zoom, and single-touch functionality of less than 1 em per frame (30 Hz) with 200 ms (lag on finger to pointer). The display, in some implementations, supports edge-to-edge glass with a minimal screen bezel that is also flush with the panel surface, and limited IO interference when using multi-touch.

UE 1700 may run various types of operating systems (OS), which may generally depend on the class of device UE 1700 is configured for. For example, for a notebook, laptop, or ultrabook, etc., the OS may generally include Windows 7, 8, or 8.1, Apple OS X (e.g., Lion (10.7), Mountain Lion (10.8), or Mavericks (10.9)), Google Chrome (for Chromebooks) or a version of Linux. For mobile devices such as mobile phones and tablets, the OS may generally include a version of Apple iOS (e.g., iOS 6 or iOS7), Google Android (e.g., 4.0 or later), Microsoft Windows Phone OS (e.g., 7.5 or 8), Windows 8, 8.1, or RT, or a BlackBerry OS (e.g., OS 10).

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a tangible non-transient machine readable medium. A memory or a magnetic or optical storage such as a disc may be the tangible non-transient machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. However, the carrier wave itself is not a tangible non-transient machine readable medium.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

It is noted that the foregoing specified software and hardware are merely illustrative, as other versions of software and hardware may be employed to provide similar functionality to that described herein without departing from the scope and spirit of the invention.

Generally, aspects of the principles and teachings of the embodiments disclosed herein may be practice using hardware, software, or any combination of software and hardware, including use of software components, modules, and applications running on physical, such as a CPU of a computer or server, or virtual machines. In addition, embedded systems may be implemented to perform aspects of the embodiments.

Thus, embodiments of this invention may be used as or to support a software program executed upon some form of processing core (such as the CPU of a computer) or otherwise implemented or realized upon or within a machine-readable medium. A machine-readable medium includes any tangible mechanism for storing information in a form readable by a machine (e.g., a computer, server, embedded system, etc.). For example, a machine-readable medium can include such as a read only memory (ROM); a random access memory (RAM); a magnetic disk storage media; an optical storage media; and a flash memory device, etc.

In the Figures, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for processing the file attachments of electronic mail messages, comprising:
receiving an electronic mail message with an attachment, the electronic mail message being addressed to at least one recipient;
determining if a copy of the attachment exists in local or remote storage; and
if a copy of the attachment exists in local or remote storage,
removing the attachment and replacing it with a means for accessing the copy of the attachment from local or remote storage; and
forwarding the electronic mail message with the means for accessing the copy of the attachment from local or remote storage to the at least one recipient.

2. The method of claim 1, further comprising:
if the copy of the attachment did not exist in local or remote storage when the message was received,
storing a copy of the attachment to at least one of local or remote storage;
removing the attachment and replacing it with a means for accessing the copy of the attachment from local or remote storage; and
forwarding the electronic mail message with the means for accessing the copy of the attachment from local or remote storage to the at least one recipient.

3. The method of claim 1, wherein the means for attaching a copy of the attachment comprises a Universal Resource Locator (URL) or Universal Naming Convention (UNC) location.

4. The method of claim 1, wherein the means for attaching a copy of the attachment comprises a short-cut that points to a stored copy of the attachment.

5. The method of claim 4, wherein the means for attaching a copy of the attachment comprises database lookup indicia, the method further comprising:
in response to a request to access the file from an electronic mail client;
employing the database lookup indicia to retrieve a database record comprising a copy of the attachment or identifying a location of a copy of the attachment; and
returning the copy of the attachment to the electronic mail client.

6. The method of claim 5, wherein the database lookup indicia comprises a database index.

7. The method of claim 1, wherein generating indicia identifying a location at which the copy of the attachment is stored comprises generating at least one database record in a database that associates file attachments, electronic mail messages, and local and remote-storage locations, that at least one database record including data identifying the location at which the copy of the attachment is stored.

8. A method, comprising:
detecting a request from an e-mail client to access the file attached to an electronic message, the request containing database lookup indicia;
performing a database query with the database lookup indicia, the database query returning a storage location of a copy of the file;
retrieving a copy of the file from the storage location;
returning the copy of the file to the e-mail client; and
updating the database to indicate a most-recent time for which access to the file was requested.

9. The method of claim 8, wherein the file was attached to at least one electronic message sent to a plurality of recipients, and a copy of the electronic file is stored on a local server; the method further comprising;
detecting that a most-recent time for which access to the file has been requested has exceeded a predetermining time period; and in response thereto,
storing a copy of the file at a location on a remote server;
updating a location of the file to be the location on the remote server; and
deleting the file on the local server.

10. A method for processing the file attachments of electronic mail messages, comprising:
receiving an electronic mail message with an attached file;
determining if the attached file is a similar to an existing file stored locally or remotely in a sub-directory; and
if the attached file is similar to a file stored locally or remotely, storing the attached file in the same sub-directory as the existing file.

11. The method of claim 10, wherein determining whether a file is similar to an existing file stored locally or remotely comprises comparing a file name of the file to the file name of one or more existing files.

12. The method of claim 10, wherein determining whether a file is similar to an existing file stored locally or remotely comprises comparing content of the file to content in one or more existing files.

13. A method for processing the file attachments of electronic mail messages, comprising:
receiving an electronic mail message with an attachment, the electronic mail message being addressed to a plurality of recipients;
storing a copy of the attachment to at least one of local or remote storage;
removing the attachment and replacing it with a means for accessing the copy of the attachment from local or remote storage;
forwarding the electronic mail message with the means for accessing the copy of the attachment from local or remote storage to each of the plurality of recipients;
detecting that each of the plurality of recipients have deleted their copy of the electronic mail message; and, in response thereto,
deleting the copy of the attachment from at least one of local and remote storage.

14. The method of claim 13, wherein the copy of the attachment is initially stored to local storage, and wherein in response to detecting that each of the plurality of recipients have deleted their copy of the electronic mail message the copy of the attachment is archived by copying the attachment to remote storage and deleting the copy of the attachment in the local storage.
